(19) United States
(12) Patent Application Publication
(10) Pub. No.: US 2008/0124202 A1
(43) Pub. Date: May 29, 2008

(54) APPARATUS FOR ROTATING A TEST TRAY IN A HANDLER

(76) Inventors: Sung-yong CHU, Jeonju-si (KR); Wan-ha Lee, Daejeon-si (KR)

Correspondence Address: KED & ASSOCIATES, LLP, P.O. Box 221200, Chantilly, VA, 20153-1200, US

(21) Appl. No.: 11/944,787

(22) Filed: Nov. 26, 2007

(30) Foreign Application Priority Data
Nov. 28, 2006 (KR) 10-2006-0118631

(51) Int. Cl. B65G 1/12

(52) U.S. Cl. 414/331.03

(57) ABSTRACT

Provided is an apparatus for rotating a test tray in a handler for handling a packaged chip for a test, including a base frame rotatable by a rotary actuator, a supporting plate slidable in a given direction by a linear actuator, supporting the test tray, a pair of first guiders provided on a lower surface of the supporting plate, slidable in the given direction along with the supporting plate, and a pair of second guiders provided on an upper surface of the base frame, slidable with respect to the pair of the first guiders.

### CROSS REFERENCE TO RELATED APPLICATIONS

This application claims priority from Korean Patent Application No. 10-2006-0118631, filed on Nov. 28, 2006, the disclosure of which is incorporated herein in its entirety by reference.

### BACKGROUND OF THE INVENTION

1. Field of the Invention

The present invention relates to a handler for handling a packaged chip for a test and more particularly to an apparatus for rotating a test tray to make it in a upright or horizontal position in a handler for handling a packaged chip for a test.

2. Description of the Related Art

At the conclusion of a packaging process, a handler puts packaged chips through a series of environmental, electrical, and reliability tests. These tests vary in type and specifications, depending on the customer and use of the packaged devices. The tests may be performed on all of the packages in a lot or on selected samples.

The handler puts packaged chips into a test tray and supplies the test tray to a tester. The tester includes a test board with a plurality of sockets, performing an electrical test on the packaged chips. The packaged chips are inserted into the sockets of the test board for the electrical test. The handler puts the packaged chips into a test tray, i.e. a jig and inserting the packaged chips contained in a test tray into sockets of the test board. The handler sorts the packaged chips according to a test result. The handler removes packaged chips from a user tray and put the removed packaged chips into carrier modules of the test tray. The handler transfers the test tray to the tester (This is referred as to “a loading operation”). The handler removes tested packaged chips from the sockets of the test tray and the tested packaged chips to a user tray (This is referred as to “an unloading operation”).

The loading and unloading operations are done in an exchanging site. In the exchanging site, the packaged chip is loaded onto the test tray and unloaded from the test tray. A test tray-rotating apparatus is provided to the exchanging site. The test tray-rotating apparatus rotates the test tray to make it in the upright or horizontal position.

The test tray-rotating apparatus includes a rotating shaft, a supporting plate connected to the rotating shaft along an axis of the rotating shaft, guiders, each of which is provided to both sides of the rotating shaft, guiding sliding motion of a test tray by engaging with edges of the test tray, and a motor rotating the rotating shaft. When the motor operates, the rotating shaft is rotated, thus rotating the test tray supported by the guiders.

One way for efficient operation of the handler is to increase a quantity of packaged chips which are tested in a given time or at a time. To do this, the test tray has to contain as many packaged chip as possible, resulting in increasing a size of the test tray.

The farther a loading unit for loading the packaged chip onto the test tray and a unloading unit for unloading the packaged chip from the test tray are located from the rotating shaft, the greater a rotating radius of the test tray-rotating apparatus is. This increases the load to a motor.

### SUMMARY OF THE INVENTION

Therefore, an object of the present invention is to provide an apparatus for rotating a large-sized test tray without applying a corresponding load to a driving unit.

According to an aspect of the present invention, there is provided an apparatus for rotating a test tray in a handler for handling a packaged chip for a test, including a base frame rotatable by a rotary actuator, a supporting plate slidable in a given direction by a linear actuator, supporting the test tray, a pair of first guiders provided on a lower surface of the supporting plate, slidable in the given direction along with the supporting plate, and a pair of second guiders provided on an upper surface of the base frame, slidable with respect to the pair of the first guiders.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a simple configuration for a handler which is equipped with a test tray-rotating apparatus according to an embodiment of the present invention;

FIG. 2 is a perspective view illustrating a test tray-rotating apparatus according to the embodiment of the present invention;

FIG. 3 is a perspective view illustrating the disassembled test tray-rotating apparatus of FIG. 2;

FIG. 4 is a perspective view illustrating a lower section of the test tray-rotating apparatus of FIG. 2;

FIG. 5 is a perspective view illustrating that the test tray-rotating apparatus of FIG. 2 slides the test tray; and

FIG. 6 is a perspective view illustrating that the test tray-tray rotating apparatus of FIG. 2 rotates the test tray.

### DETAILED DESCRIPTION OF EXEMPLARY EMBODIMENTS

Reference will now be made in detail to the preferred embodiments of the present invention, examples of which are illustrated in the accompanying drawings.

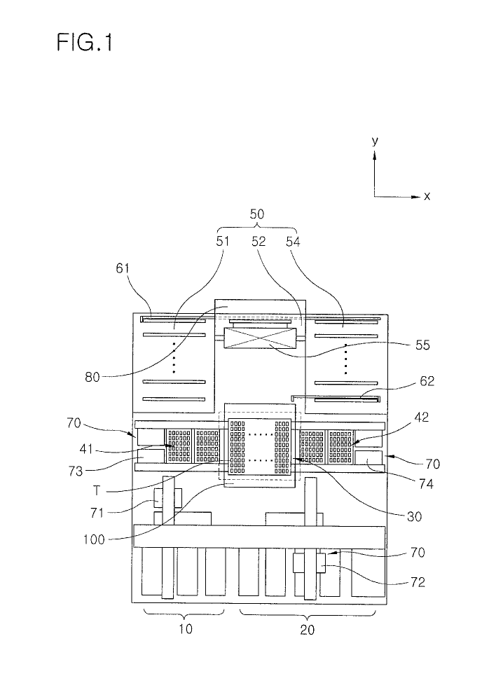

FIG. 1 is a view showing a simple configuration for a handler which is equipped with a test tray-rotating apparatus according to an embodiment of the present invention.

As shown in FIG. 1, a handler for handling a packaged chip for a test includes a loading stacker 10, an unloading stacker 20, an exchanging site 30, a test unit 50 and a picker 70.

The loading stacker 10 is provided to a forward section of a main body of the handler. A user tray containing packaged chips stays in the loading stacker 10. The unloading stacker 20 is provided adjacent to the loading stacker 10. User trays, each of which selectively contains a tested packaged chip according to a test result, stay in the unloading stacker. Each user tray contains the tested packaged chips having the same grade as a test result.

The exchanging site 30 is located behind the loading and unloading stackers 10 and 20. A test tray T stays in the exchanging site 30. To-be-tested packaged chips are supplied from the loading stacker 10 to the exchanging site 30. In the exchanging site 30, the to-be-packaged chips are loaded onto the test tray T. In the exchanging site 30, the tested packaged chips are unloaded from the test trays T and are transferred to the unloading stacker 20.

A loading buffer 41 and a unloading buffer 42 are located adjacent to both sides of the exchanging site 30, respectively. The packaged chips temporarily wait in the loading and unloading buffers 41 and 42. The unloading and unloading buffers 41 and 42 are movable backwards and forwards.

The test unit 50 is provided behind the exchanging site 30. The test unit 50 receives from the exchanging site 30 the test tray containing the to-be-tested packaged chips. In the test unit 50, a tester performs tests on the to-be-tested packaged chips. The test unit provides testing environments in which the packaged chips are tested at extremely high or low temperatures as well as at room temperature.

The test unit 50 includes a first chamber 51, a second chamber 52, and a third chamber. The test tray containing the packaged chip goes through the first chamber, the second chamber, and the third chamber, in this order. In the first chamber 51, the packaged chips in the test tray T are heated to extremely high or low temperature.

In the test chamber 52, the tester performs the test on the extremely high-heated or low-cooled packaged chips. A test board 80 provided to the tester is located in the upright position behind the second chamber. The test board 80 has a plurality of sockets. One packaged chip is inserted into one socket.

A pushing unit 55 is provided in the second chamber 52. The pushing unit 55 pushes the test tray T toward the test board, to insert the packaged chips into the sockets of the test board, respectively. The pushing unit 55 can be moved backwards and forwards to pull and push the test board T In the third chamber 54, the tested packaged is cooled or heated to room temperature. A first tray-transferring apparatus 61 may be provided when the first chamber and the third chamber are provided with the second chamber in between,

The first tray-transferring apparatus 61 transfers the test tray T from the first chamber 51 to the second chamber 52 and then from the second chamber to the third chamber. There is no limitation on how the first, second, and third chambers 51, 52 and 54 are arranged relative to each other. The first, second, and third chambers 51, 52 and 54 may be arranged in a row, or in a column, or in a row and columns.

The picker 70 is moved backwards and forwards between the exchanging site 30, the loading stacker 10 and the unloading stacker 20 to pick up the packaged chip from the test tray or place the packaged chip in the test tray.

The picker 70 may include a first loading picker 71, and a first unloading picker 72 which are moved over the forward section of the handler, and a second loading picker 73 and a second unloading picker 74 which are moved over the exchanging site 30 and the loading and unloading buffers 41 and 42.

The first loading picker 71 is moved between the loading stacker 10 and the loading buffer 41 in the X-axis and Y axis directions to pick up, transfer, and place the packaged chip. The first unloading picker 72 is moved between the unloading stacker 20 and the unloading buffer 42 in the X-axis and Y axis directions to pick up, transfer, and place the packaged chip. The second loading picker 73 and the second unloading picker 74 are moved between the loading and unloading buffer 41 and 42 and the exchanging site 30 in the X-axis direction to pick up, transfer, and place the packaged chip.

A test tray-rotating apparatus 100 according to the embodiment of the present invention is provided in the exchanging site 30. The test tray-rotating apparatus 100 transfers the test tray T in the Y-axis direction by a given distance, after holding the test tray T firmly in position. At this point, the to-be-tested packaged chip is loaded onto the test tray T from the loading buffer 41 and the tested package chip is unloaded from the test tray T onto the unloading buffer 42.

The test tray-rotating apparatus 100 rotates the horizontally-positioned test tray T by 90 degrees to make it in the upright position before a second tray transferring apparatus 62 transfers the upright-positioned test tray T.

The second tray-transferring unit 62 transfers the upright-positioned test tray to the test tray-rotating apparatus 100 from the test unit 50. Then the test tray-rotating apparatus rotates the upright-positioned test tray T by 90 degrees to make it in the horizontal position before the test tray T is transferred back to the exchanging site 30.

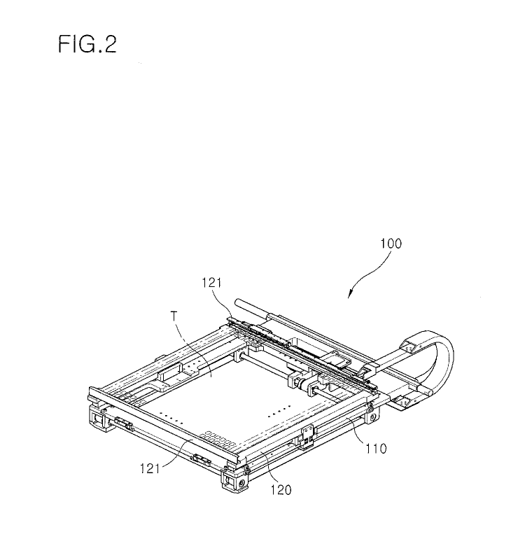

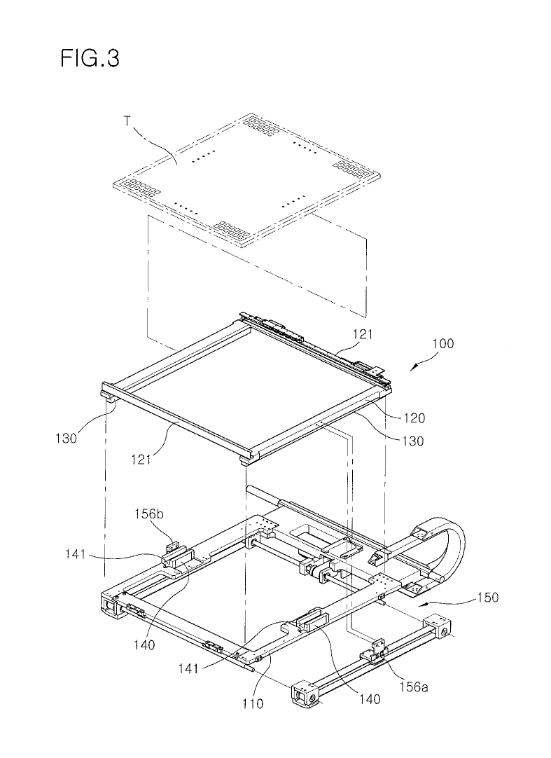

The test tray-rotating apparatus 100, as shown in FIGS. 2 and 3, includes a base frame 110, a supporting plate 120, a pair of first guiders 130, a pair of second guiders 140, a linear actuator 150, and a rotary actuator 160.

The base frame 110 is rectangular as the test tray T, but limited to the rectangular shape. The linear actuator 150 is provided to the base frame 110.

The base frame 110 has a large opening from the upper surface to the lower surface. This reduces a load applied to the rotary actuator 160. Thus, the rotary actuator 160 can rotate the lighter base frame 110 than it would otherwise do.

A detecting unit and a loading/unloading unit may be provided to occupy the space created by the opening. The detecting unit is for detecting whether the packaged chip is properly contained in the test tray. The loading/unloading units are for loading and unloading the packaged chip onto and from the test tray.

The supporting plate 120 serves to support the test tray T. The supporting plate 120 is provided over the base frame 110. The supporting plate 120 is rectangular as the test tray T. The shape of the supporting plate 120 may vary with that of the test tray T.

Like the base frame 110, the supporting plate 120 has a large opening from the upper surface to the lower surface. This reduces a load applied to the rotary actuator 160. Thus, the rotary actuator 160 can rotate the lighter supporting plate 120 than it would otherwise do. The rotary actuator 160 rotates the base frame 110 and the supporting plate 120. The supporting plate 120 is connected to the base frame 110, with the pair of first guiders 130 and the pair of second guiders 140 in between.

The supporting plate 120 supporting the test tray T can be slid in one direction by the linear actuator 150. For example, the supporting plate 120, as shown in FIG. 1, can be slid in the X-axis direction. The supporting plate 120, which is slid backwards and forwards in the Y-axis direction, is now described for explanatory convenience.

A supporting bracket 121 is provided to the supporting plate 120, to support the upright-positioned or horizontally-positioned test tray T.

The supporting brackets 121 are provided on the front-end and rear-end portions of the upper surface of one supporting plate 120, in the direction perpendicular to the direction of the supporting plate 120. The supporting bracket 121 supports the upright-positioned test unit T which the tray-transferring unit 62 transfers to and from the supporting plate 120. Both end portion of the supporting bracket 121 are lengthwise bent to cover both edges of the test tray T and thereby to support the test tray T.

The first guiders 130 and the second guiders 140 cooperates to guide sliding motion of the supporting plate 120 which is generated by the linear actuator 150. At least two first guides are spaced and arranged to each other under the supporting plate 120.

The first guiders 130 can be provided to both ends of the lower surface of the supporting plate 120, respectively, when the supporting plate 120 has the opening from the upper surface to the lower surface. The first guiders 102 and the supporting plate 120 may be formed as a single body. The first guiders 130 may be connected to the supporting plate 120 with a fastener. The first guiders 130 are slid along with the supporting plate 120. The length of the first guider 130, as shown in FIG. 3, is preferably equal to or larger than that of the supporting plate 120. This enables the supporting plate 120 to be slid as far as possible from the base plate 110 and the second guiders 140 to be shorter than the first guiders 130.

In a case where the second guider 140 is shorter in length than the first guider 130, the base frame 110 can be kept unchanged in length even though the supporting plate 120 becomes longer in length due to the increasingly large-sized test tray T.

For a comparative example, in a case where the second guider 140 is longer in length than the first guider 130, the base frame 110 has to be longer in length to allow the supporting plate 120 to slide when the supporting plate 120 becomes longer in length.

In summary, according to the embodiment of the present invention, even though the supporting plate 120 becomes large in size due to the increasingly large-sized test tray T, it is possible to reduce the size of the base frame 110 compared to the above-mentioned comparative example. Therefore, it is possible to reduce the weight of the base frame 110 compared to the above-mentioned comparative example, thereby reducing the drive force of the rotary actuator 160 to rotate the base frame 110.

The pair of the second guiders 140, are provided on the upper surface of the base frame 110, to correspond to the pair of the first guiders 130, respectively. The second guiders 140 are provided to be slid with respect to the first guiders 130, respectively.

The second guider 140 has a connection hollow 141 in the sliding direction of the supporting plate 120. The first guider 130 is inserted into the connection hollow 141. Thus, the first and second guiders 130 and 140 are engaged with each other. The first guider 130, instead of the second guider 140, may have the connection hollow 141.

The second guider 140 is shorter than the first guider 130. However, the length of the second guider 140 is such that the second guider 140 can stably support the supporting plate 120.

That is, the length of the supporting plate 120 has to be so long that the first and second guiders 130 and 140 remain engaged even when the supporting plate 120 is slid the farthest away from the base frame 110.

The second guiders 140 and the base frame 110 may be formed as a single body. The second guiders 130 may be fixed to the base frame 110 with a fastener.

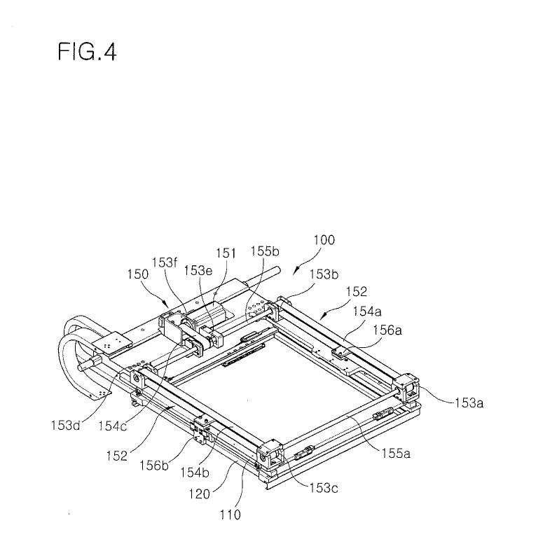

The linear actuator 150, as shown in FIG. 4, slides the supporting plate 120 with respect to the base frame 110.

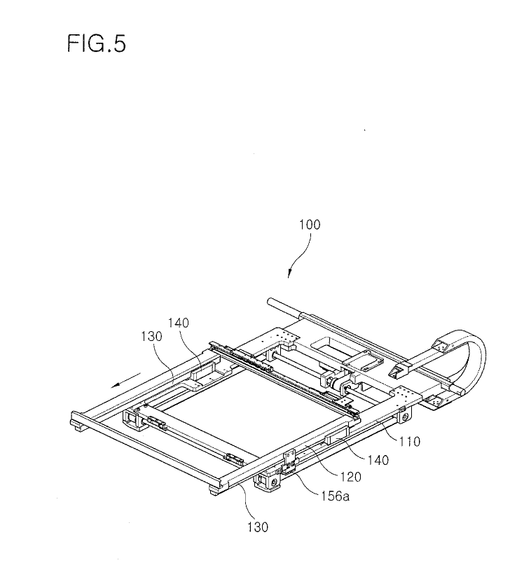

The linear actuator 150 includes a motor 151 and a motion transforming unit 152. The motor 151, which is capable of generating rotary motion clockwise or counter-clockwise, is provided to the base frame 110. The motion transforming unit 152 transforms rotary motion into linear motion and provides the linear motion to the supporting plate 120. Thus, the supporting plate 120 is slidable, as shown in FIG. 5.

The motion transforming unit 152 includes pulleys 153a through 153f, belts 154a through 154c, and connection rods 155a and 155b.

The first and second pulleys 153a and 153b is provided to one side of the base frame 110 and the third and fourth pulleys 153c and 153d is provided to the other side of the base frame 110.

The first belt 154a connects the first and second pulleys 153a and 153b. The second belt 154b connects the third and fourth pulleys 153c and 153d. Moving blocks 156a and 156b are fixed to the first and second belts 156a and 156b, respectively. The first and second moving blocks 156a and 156b are fixed to both sides of the supporting plate 120, respectively.

The first connection rod 155a connects the first and third pulley 153a and 153c. Thus, the first and third pulley 153a and 153c are simultaneously rotated. The second connection rod 155b connects the second and fourth pulley 153b and 153d. Thus, the first and third pulley 153b and 153d are simultaneously rotated. The fifth pulley 153e is provided in the middle of the second connection rod 155b. Thus, the fifth pulley 153e is rotated as the second connection rod 155b is rotated. The sixth pulley 153f is provided to a rotating shaft of the motor 151. The third belt 154c connects the sixth pulley 153f and the fifth pulley 153e.

Operation of the motion transforming unit 152 is now described. The motor 151 rotates the rotating shaft. Rotation of the rotating shaft is followed by rotation of the sixth pulley 153f. The rotation of the sixth pulley 153f is followed by rotation of the third belt 154c. The rotation of the third belt 154c is followed by the fifth pulley 153e. The rotation of fifth pulley 153e is followed by rotation of the second connection rod 155b. The rotation of the second connection rod 155b is followed by rotation of the second and fourth pulleys 153b and 153d. The rotation of the second and fourth pulleys 153b and 153d is followed by the first and second belts 154a and 154b. The rotation of the first and second belts 154a and 154b is followed by rotation of the first and third pulleys 153a and 153c.

When the pulleys 153a through 153d are rotated, the first and second 154a and 154b are moved in a straight line over a given distance. At this point, the first and second moving blocks 156a and 156b fixed to the first and second belts 154a and 154b, respectively, are moved in a straight line over a given distance. Thus, the supporting plate 120 fixed to the first and second moving blocks 156a and 156b, as shown in FIG. 5, is made to be slid.

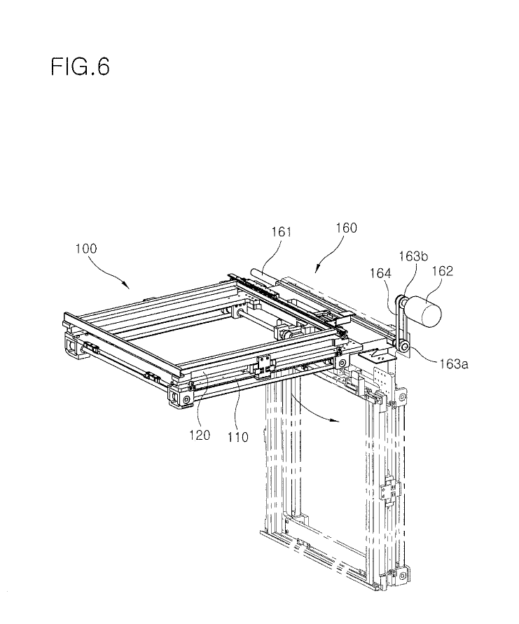

The rotary actuator 160, as shown in FIG. 6, rotates the test tray T supported by the supporting plate 120. At this point, the supporting plate 120 remains in the base frame 110, without being slid away from the base frame 110. This is done to keep rotating radii of the supporting plate 120 and the base frame 110 to a minimum.

The rotary actuator 160 may be set to rotate the test tray T clockwise or counterclockwise within a range of 90 degrees. As an example, the rotary actuator 160 includes a shaft 161 fixed to a rear side of the base frame 110 and a motor 162 rotating the shaft 161 clockwise or counterclockwise.

The shaft 161 transforms rotary motion of the rotary actuator 162 into clockwise or counterclockwise rotary motion. Thus, the base frame 110 can be rotated clockwise or counterclockwise. Accordingly, the first and second guiders 130 and 140 is rotated, and thus the test tray T supported by the supporting plate 120 is rotated.

Rotary motion of the motor 162 may be transferred to the shaft 161, with motion-transferring devices. The motion-transferring device includes at least a pair of pulleys 163a and 163b and a belt 164.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for rotating a test tray in a handler for handling a packaged chip for a test, comprising:
a base frame rotatable by a rotary actuator;
a supporting plate slidable in a given direction by a linear actuator, supporting the test tray;
a pair of first guiders provided on a lower surface of the supporting plate, slidable in the given direction along with the supporting plate; and
a pair of second guiders provided on an upper surface of the base frame, slidable with respect to the pair of the first guiders.

2. The apparatus according to claim 1, wherein each of the second guides is shorter in length than each of the first guides.

3. The apparatus according to claim 2, wherein each of the first guiders is equal in length to or larger in length than the supporting plate.

4. The apparatus according to claim 1, wherein the linear actuator comprises a motor whose rotating shaft rotates clockwise and counterclockwise, and a motion transforming unit for transforming rotary motion of the rotating shaft generated by the motor into linear motion of the supporting plate to slide the supporting plate.

5. The apparatus according to claim 1, wherein the rotary actuator rotates the base frame within a range of 90 degrees to rotate the test tray clockwise or counterclockwise within a range of 90 degrees.
